(19) United States
(12) Patent Application Publication
(10) Pub. No.: US 2011/0097484 A1
(43) Pub. Date: Apr. 28, 2011

(54) LENS HOLDING TOOL, LENS HOLDING METHOD, AND LENS PROCESSING METHOD

(76) Inventor: Koichi Sakai, Tokyo (JP)

(21) Appl. No.: 12/934,993

(22) PCT Filed: Mar. 13, 2009
(86) PCT No.: PCT/JP2009/054904

§ 371 Date: Dec. 17, 2010

(30) Foreign Application Priority Data
Mar. 28, 2008 (JP) 2008087228

(51) Int. Cl. B05D 5/06; B25B 11/00; B05C 13/02

(52) U.S. Cl. 427/164; 269/21; 29/559

(57) ABSTRACT

A lens holding tool (1) includes a cylindrical jig main body (10) having an opening (19), a vent hole (13), and a hollow portion (18), and a ring-like lens holding body (20) formed of an elastic body. The lens holding body (20) includes a holding portion (21) and a fitting portion (22). The fitting portion (22) is fitted on the outer surface of the jig main body (10). When the hollow portion (18) is evacuated, the holding portion (21) sucks and holds the outer peripheral edge (24) of a lens (100).

### TECHNICAL FIELD

The present invention relates to a lens holding tool, lens holding method, and lens processing method used when coating a lens such as a plastic lens.

### BACKGROUND ART

A plastic or glass lens for spectacles or the like has various types of coating layers, e.g., a primer layer or hard coating layer to improve the shock resistance or hardness, and an anti-reflection film on its surface. Methods to form these layers are roughly divided into methods employing a wet process and methods employing a vacuum process such as vacuum deposition. The method employing a wet process has an advantage in that an apparatus for the method is comparatively compact and has a simple arrangement.

As the method of forming a thin film by a wet process, generally, a film is formed on the lens surface by spin coating or the like which applies a liquid or atomized material to the lens surface while rotating the lens, and after that the material is cured by ultraviolet curing or the like. In this case, the film thickness varies in a coating step, causing a problem. The variations in film thickness are supposed to result from the nonuniform temperature distribution in the lens.

As a technique that solves the problem of variations in film thickness, for example, a lens holding tool disclosed in Japanese Patent Laid-Open No. 2006-231282 is proposed. With this lens holding tool, the lens is sucked and held by evacuating the interior of the holding tool through an air-permeable elastic body, and heat transfer from the lens holding tool to the lens is interrupted by the elastic body.

### DISCLOSURE OF INVENTION

### Problem to be Solved by the Invention

However, since the lens holding tool proposed in Japanese Patent Laid-Open No. 2006-231282 sucks the lens through the air-permeable elastic body, the contact area of the elastic body with the optical surface must be large to a certain degree. For this purpose, the elastic body has a doughnut- or disc-like shape, and sucks and holds a considerably wide portion of the lens extending to near the center of the optical surface. As a result, in a process such as ultraviolet curing that generates heat, heat of the lens is not dissipated easily, but is transferred to the effective optical surface of the lens, that is, an optical surface at the center that forms a lens shape coinciding with the edged spectacle frame shape. This adversely affects a film to be formed by coating.

Particularly, it is known that, when sequentially holding a plurality of lenses by a lens holding tool and performing a process such as coating and curing, after the third to fifth lenses are processed, the heat accumulated in the lens holding tool is undesirably transferred to the subsequent lens. More specifically, when the plurality of lenses are to be processed consecutively, a temperature distribution is formed on the lens surface by heat transferred from the lens holding tool, and accordingly the thickness of the film formed by coating varies. Such thickness variations in coating film form interference fringes which become apparent particularly when the refractive index of the lens as the base material and that of the coating film are largely different, leading to a defective appearance. Therefore, heat transfer to the optical surface must be minimized.

The present invention has been made to solve the conventional problem as described above, and has as its object to suppress heat conduction between the lens holding tool and lens, thereby reducing variations in film thickness of a coating surface to be formed on the lens optical surface.

### Means of Solution to the Problem

In order to solve the above problem, a lens holding tool according to the present invention comprises a cylindrical jig main body including an opening, a vent hole, and a hollow portion communicating with the vent hole, and a ring-like lens holding body formed of an elastic body, wherein the lens holding body includes a fitting portion which fits with the jig main body and a holding portion which holds an outer peripheral edge of a lens as a holding target, and upon evacuation through the vent hole, the hollow portion is evacuated, and the holding portion deforms, thereby sucking and holding the lens.

A lens holding method according to the present invention comprises the steps of preparing a lens holding tool in which a lens holding body including a fitting portion and a holding portion and formed of a ring-like elastic body is fitted with an edge of an opening of a cylindrical jig main body including the opening, a vent hole, and a hollow portion communicating with the vent hole, mounting a lens on the lens holding tool, attaching exhaust means to a region surrounding the vent hole of the jig main body, and evacuating an interior of the lens holding tool by the exhaust means, thereby sucking and holding an outer peripheral edge of the lens by the lens holding tool.

A lens processing method according to the present invention comprises the steps of preparing a lens holding tool in which a lens holding body including a fitting portion and a holding portion and formed of a ring-like elastic body is fitted with an edge of an opening of a cylindrical jig main body including the opening, a vent hole, and a hollow portion communicating with the vent hole, mounting a lens on the lens holding tool, attaching exhaust means to a region surrounding the vent hole of the jig main body, evacuating an interior of the lens holding tool by the exhaust means, thereby sucking and holding an outer peripheral edge of the lens by the lens holding tool, moving the lens holding tool to a processing bath that processes a surface of the lens, and processing the surface of the lens.

### EFFECT OF THE INVENTION

According to the present invention, heat conduction between the lens holding tool and lens optical surface can be suppressed. More specifically, when holding the lens by the lens holding tool, the lens is mounted on the lens holding body. The hollow portion in the jig main body is evacuated through the vent hole, so the lens holding body sucks and holds the outer peripheral edge of the lens. Even when the hollow portion is evacuated, the outer peripheral edge of the lens is supported by the jig main body through the lens holding body. Thus, most of the region of the optical surface on the hollow portion side is not in contact with the lens holding body. This suppresses heat from being retained in the lens in a process such as ultraviolet irradiation. Also, as the lens is in contact with the lens holding body with only its outer peripheral edge, heat transfer from the lens holding tool to the lens optical surface can be suppressed reliably. As a result, nonuniform temperature distribution at the center of the optical surface can be prevented.

Therefore, when processing a plurality of lenses consecutively as well, the temperature rise of the lens holding tool due to heat accumulated in it is suppressed, so that heat transfer from the lens holding tool to the surface of a new lens to be processed next can be suppressed. More specifically, even after the surfaces of the plurality of lenses are processed, nonuniform temperature distribution on a lens to be processed after the several lenses can be avoided. This can reduce variations in thickness of a thin film which is formed on the optical surface by coating, and consequently improve the lens productivity.

The outer peripheral edge of the optical surface in the present invention refers to the side surface (edge surface) of a lens and the outer periphery of an optical surface of the lens on a side opposite to a coating-side optical surface which is connected to the side surface, or at least either one of the side surface and outer periphery. The outer periphery of the optical surface is a portion outside a lens shape that coincides with the edged spectacle frame shape.

### BRIEF DESCRIPTION OF DRAWINGS

FIG. 1A is a perspective view of a lens holding tool according to the first embodiment of the present invention which is seen from an upper surface side;

FIG. 1B is a perspective arrangement view of the lens holding tool seen from an opening side;

FIG. 1C is a perspective view of a jig main body seen from an opening side;

FIG. 1D is a perspective view of the jig main body seen from an upper surface side;

FIG. 1E is a perspective view of a lens holding body seen from an edge side;

FIG. 2 is a sectional view showing a state in which a lens is held by the lens holding tool according to the first embodiment of the present invention;

FIG. 3A is a perspective view of a lens holding tool according to the second embodiment of the present invention which is seen from an upper surface side;

FIG. 3B is a perspective view of the lens holding tool seen from an opening side;

FIG. 3C is a perspective view of a jig main body seen from an opening side;

FIG. 3D is a perspective view of the jig main body seen from an upper surface side;

FIG. 3E is a perspective view of a lens holding body seen from an edge side;

FIG. 4 is a sectional view showing a state in which a lens is held by the lens holding tool according to the second embodiment of the present invention;

FIG. 5 is a sectional view showing a state in which a lens is held by a lens holding tool according to the third embodiment of the present invention;

FIG. 6A is a perspective view of a lens holding tool according to the fourth embodiment of the present invention;

FIG. 6B is a sectional view showing a state in which the convex optical surface of a lens is sucked and held by the lens holding tool;

FIG. 6C is a sectional view showing a state in which the concave optical surface of the lens is sucked and held by the lens holding tool;

FIG. 7 is a plan view showing an example of the arrangement of a lens processing apparatus; and

FIG. 8 is a flowchart showing steps in an example of a lens holding method and lens processing method according to an embodiment of the present invention.

### BEST MODE FOR CARRYING OUT THE INVENTION

Examples of the best mode for carrying out the present invention will be described hereinafter. Note that the present invention is not limited to the following examples.

### (1) First Embodiment

### Lens Holding Tool

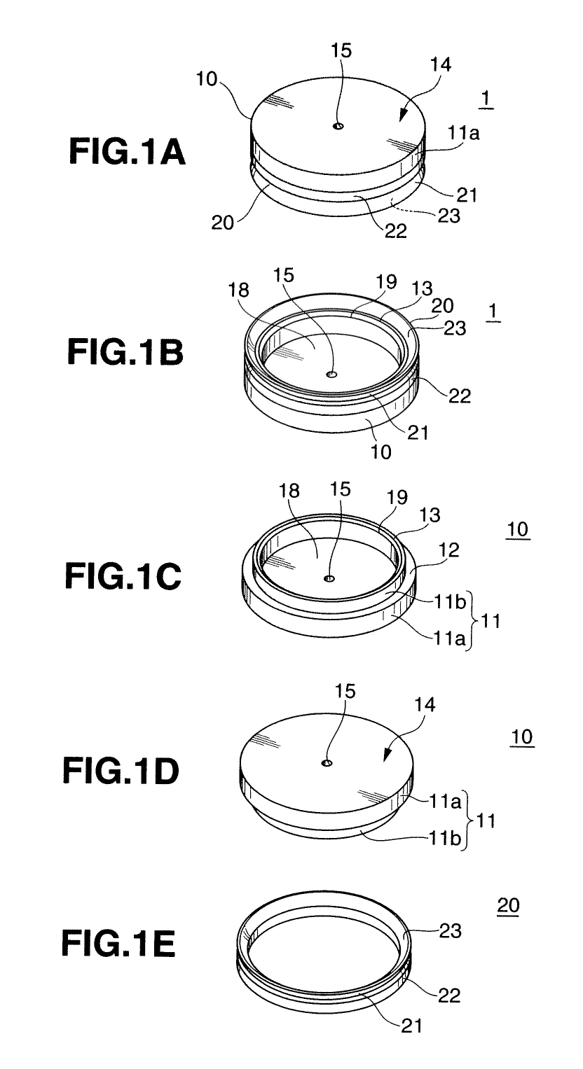

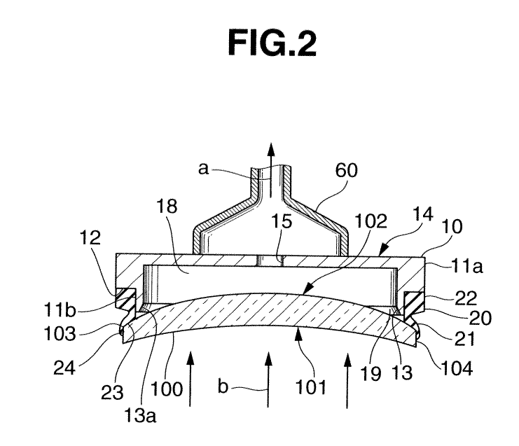

Referring to FIGS. 1A to 1E and FIG. 2, a lens holding tool 1 according to the first embodiment of the present invention includes a jig main body 10 and lens holding body 20.

In FIGS. 1C and 1D, the jig main body 10 is formed into an almost cylindrical shape with one open end using a material having comparatively low thermal conductivity, e.g., a synthetic resin, so it includes a cylindrical portion 11 and circular flat upper plate portion 14. The cylindrical portion 11 includes a ring-like first cylindrical portion 11a continuous to the upper plate portion 14, and a ring-like second cylindrical portion 11b having an outer diameter smaller than that of the first cylindrical portion 11a. One end of the second cylindrical portion 11b forms an edge 13 of an opening 19. A step 12 between the first cylindrical portion 11a and second cylindrical portion 11b forms a ring-like flat surface parallel to the upper plate portion 14. The lens holding body 20 (to be described later) is fitted on the outer surface of the second cylindrical portion 11b to cover a portion between the edge 13 of the opening 19 and the step 12. The inner side of the jig main body 10 forms an almost cylindrical hollow portion 18. A vent hole 15 extending through the upper plate portion 14 and communicating with the hollow portion 18 is formed at almost the center of the upper plate portion 14.

The vent hole 15 suffices as far as it has a size and shape that enable evacuation of the interior of the jig main body 10, i.e., the hollow portion 18, appropriately within a normal process time by an exhaust means attached in tight contact with the upper surface of the upper plate portion 14. For example, when holding a lens having a general diameter of approximately 80 mm or less, if the vent hole 15 has a diameter of less than 2 mm, suction cannot be performed sufficiently. Hence, in this case, the vent hole 15 desirably has a diameter of 2 mm or more, or 3 mm or more. The upper limit of the vent hole 15 suffices as far as it is smaller than the size of the contact surface of an exhaust means 60 that comes into contact with the upper surface of the jig main body 10. For example, when the jig main body 10 is to be connected to the exhaust means through a sucking pad 60 or the like, as shown in FIG. 2, the diameter of the vent hole 15 may be less than the inner diameter of the distal end opening of the sucking pad 60.

The jig main body 10 is not limited to a cylindrical one as in the example shown in the drawings, but can have another appropriate shape, e.g., an elliptic or polygonal cylindrical shape. The closed end (upper surface side) of the jig main body 10 may be spherical, and can have any shape as far as it can stably hold the hollow portion 18 during evacuation Desirably, the hollow portion 18 has such a shape that it can be evacuated easily. The vent hole 15 can be formed at any position as far as when connecting the exhaust means 60 to the jig main body 10, the connecting portion of the exhaust means 60 can cover the vent hole 15 and hold the air tightness.

Referring to FIG. 1E, the lens holding body 20 includes a ring-like holding portion 21 and ring-like fitting portion 22. The holding portion 21 is formed of an elastic body of elastomer or the like, has, e.g., a V-shaped section, and serves as a portion that holds a lens 100 (Fig. The fitting portion 22 fits with the second cylindrical portion 11b of the jig main body 10 described above. The inner diameter of the fitting portion 22 is smaller than the outer diameter of the second cylindrical portion 11b. Thus, when the fitting portion 22 of the elastic lens holding body 20 extends and is fitted with the second cylindrical portion 11b of the jig main body 10, the fitting portion 22 comes into sufficient tight contact with the second cylindrical portion 11b, so air leakage can be prevented. The inner diameter of the holding portion 21 is smaller than the outer diameter of the lens 100 to be fitted in the holding portion 21. Thus, when the lens 100 is fitted in the holding portion 21, the holding portion 21 comes into tight contact with an outer peripheral edge 24 of the lens 100, so air tightness is maintained. In this case, this embodiment exemplifies a case in which, as shown in FIG. 2, the outer peripheral edge 24 of the lens 100 which comes into tight contact with the lens holding body 20 includes both the outer periphery of, two optical surfaces 101 and 102 of the lens 100, an optical surface on the lens holding tool 1 side, i.e., the optical surface 102 on a side opposite to the optical surface 101 that is to undergo coating, and a side surface (edge surface) 104. In other words, the holding portion 21 holds an outer periphery 103 (corner) of the lens 100 where the convex optical surface 102 and side surface 104 intersect. The lens 100 may be held to a certain degree even when sucking by the exhaust means is stopped. Alternatively, the holding portion 21 does not cover the side surface 104 of the lens 100, but may come into tight contact with the outer peripheral edge 24 of the optical surface 102 on the lens holding tool 1 side like a suction cup, thus holding the lens 100. When the lens holding body 20 is fitted with the second cylindrical portion 11b of the jig main body 10, the lens holding tool 1 shown in FIGS. 1A and 1B can be obtained.

Referring to FIG. 2, the sucking pad 60 is made of elastomer or the like to have a funnel shape, provided at the distal end of the exhaust means (not shown), and attached to a position of the upper plate portion 14 of the jig main body 10 surrounding the vent hole 15 to be in tight contact with the upper plate portion 14. The lens 100 is fitted with an inner edge 23 of the V-shaped holding portion 21 of the lens holding body 20. In this case, as described above, FIG. 2 shows a state in which the inner edge 23 of the holding portion 21 is in tight contact with that region of one optical surface 102 of the lens 100 which ranges from the outer periphery 103 to the side surface 104, thus holding the lens 100. At this time, the interior of the lens holding tool 1, that is, the hollow portion 18 is hermetically closed.

In this state, when the interior of the lens holding tool 1 is evacuated by the exhaust means as indicated by an arrow a in FIG. 2, the hollow portion 18 is evacuated. Thus, the lens 100 comes into tight contact with the edge 13 of the holding portion 21 by the suction force, so it is stably sucked and held by the holding portion 21. At this time, the holding portion 21 elastically deforms toward the jig main body 10 by the suction force. As shown in FIG. 2, the edge 13 of the jig main body 10 desirably forms a taper surface inclined inward, so if the optical surface 102 of the lens 100 on the lens holding tool 1 side is a convex, the edge 13 does not come into contact with the lens 100.

After sucking and holding the lens 100, the lens holding tool 1 is transported to a surface processing apparatus (not shown), and the optical surface 101 of the lens 100 undergoes coating. For example, the concave optical surface 101 of the lens 100 undergoes a surface process such as coating of a coating material by a processing apparatus such as a coating bath. In this case, after coating the coating material, the lens holding tool 1 is moved to a curing bath that performs curing by ultraviolet irradiation or the like, and curing by ultraviolet irradiation or the like is performed as indicated by an arrow b in FIG. 2. At this time, the lens 100 is in contact with the lens holding tool 1 through only the outer peripheral edge 24. Thus, the area of the lens 100 which is in the direction of ultraviolet irradiation is considerably smaller than in a case in which the lens 100 is held by a conventional sucking pad or the like. In addition, most of the area of the convex optical surface 102 is not in contact with the lens holding body 20. Hence, heat is not retained in the lens 100 but is dissipated outside, so heat accumulation in the lens holding tool 1 is suppressed. This can reliably reduce temperature rise of the lens holding tool 1.

### (2) Second Embodiment

### Lens Holding Tool

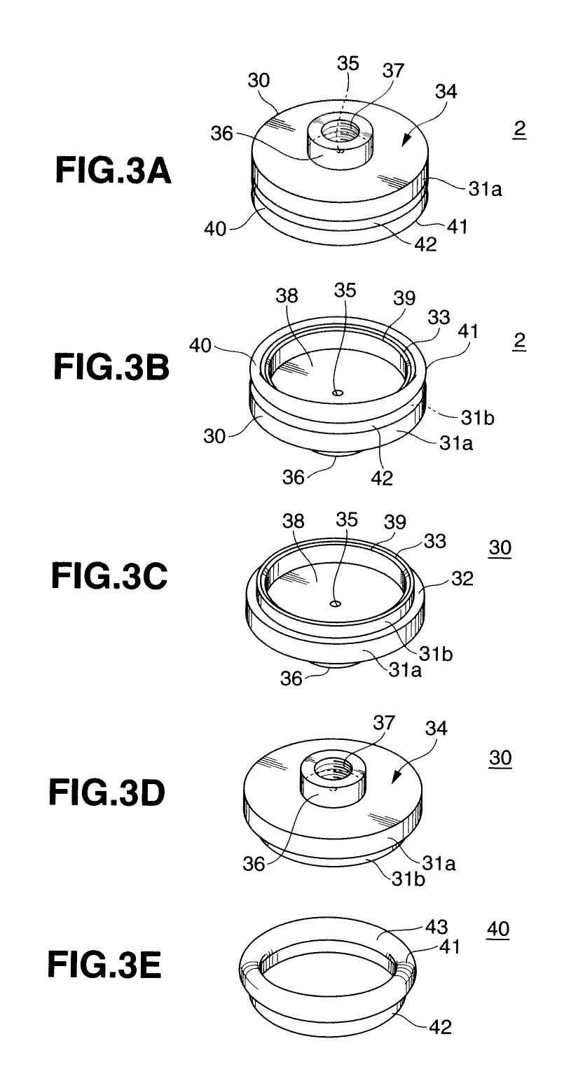

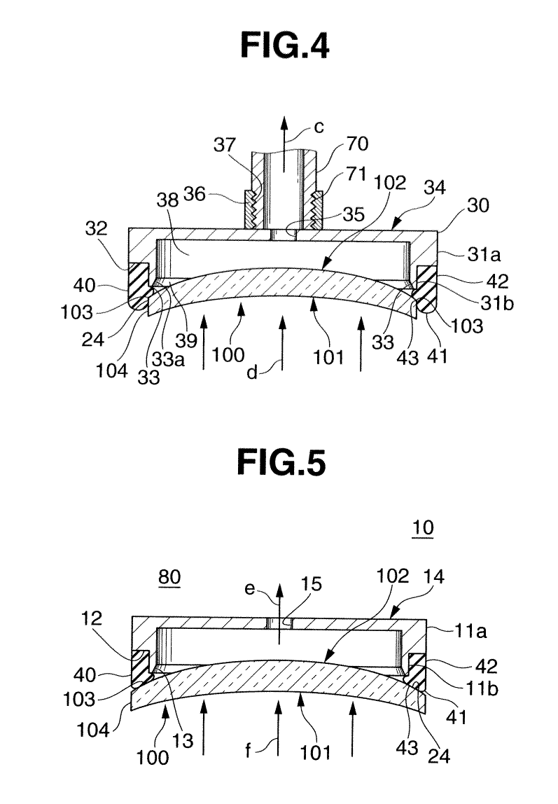

A lens holding tool according to the second embodiment of the present invention will be described with reference to FIGS. 3A to 3E and FIG. 4.

A lens holding tool 2 according to the second embodiment includes a jig main body 30 and lens holding body 40. The jig main body 30 is formed into a cylindrical shape with one open end using a material having comparatively low thermal conductivity, e.g., a synthetic resin, so it includes a cylindrical portion 31 and circular flat upper plate portion 34. The cylindrical portion 31 includes a first cylindrical portion 31a continuous to the upper plate portion 34, and a second cylindrical portion 31b having an outer diameter smaller than that of the first cylindrical portion 31a. A step 32 between the first cylindrical portion 31a and second cylindrical portion 31b forms a ring-like flat surface parallel to the upper plate portion 34. The lens holding body 40 is fitted on the outer surface of the second cylindrical portion 31b to cover a portion between an edge 33 of an opening 39 and the step 32. The interior of the jig main body 30 forms a cylindrical hollow portion 38. A vent hole 35 extending through the upper plate portion 34 is formed at almost the center of the upper plate portion 34. The vent hole 35 suffices as far as it communicates with the hollow portion 38 and has a size and shape that enable evacuation of the interior of the jig main body 30 appropriately within a normal process time by an exhaust means 70 (FIG. 4) attached to the upper plate portion 34. The vent hole 35 can have a size and shape similar to those of the vent hole of he jig main body 10 of the first embodiment.

The jig main body 30 of this embodiment has, around the vent hole 35, a connecting portion 36 projecting from the upper plate portion 34 and having, e.g., a cylindrical shape. A thread groove 37 to be threadably connected to the exhaust means 70 (to be described later) is formed on the inner surface of the connecting portion 36.

Referring to FIGS. 3E and 4, the lens holding body 40 of this embodiment includes a ring-like holding portion 41 and ring-like fitting portion 42. The holding portion 41 is formed of an elastic body of elastomer or the like, holds a lens 100, and has, e.g., an O-shaped section. The fitting portion 42 fits with the second cylindrical portion 31b of the jig main body 30 described above. The inner diameter of the fitting portion 42 is smaller than the outer diameter of the second cylindrical portion 31b of the jig main body 30. Thus, when the fitting portion 42 of the elastic lens holding body 40 extends and is fitted with the second cylindrical portion 31b of the jig main body 30, the fitting portion 42 comes into sufficient tight contact with the second cylindrical portion 31b, so air leakage is prevented. The inner diameter of the holding portion 41 is smaller than the outer diameter of the lens 100 to be fitted in the holding portion 41. Thus, when the lens 100 is fitted in the holding portion 41, the holding portion 41 enlarges in diameter and comes into tight contact with an outer peripheral edge 24 of the lens 100, so air tightness is maintained. As shown in FIG. 4, the lens holding tool 2 according to the second embodiment sucks and holds the outer periphery of a convex optical surface 102 and side surface 104 of the lens 100. In this case as well, the lens 100 may be held to a certain degree when sucking by the exhaust means 70 is stopped. Alternatively, the lens holding tool 2 does not cover the side surface 104 of the lens 100, but may suck and hold only the outer periphery of the optical surface 102. When the lens holding body 40 is fitted with the second cylindrical portion 31b of the jig main body 30, the lens holding tool 2 shown in FIGS. 3A and 3B can be obtained.

In the state shown in FIG. 4, that is, in a state in which the lens 100 is mounted on the lens holding tool 2, the connecting portion 36 of the upper plate portion 34 of the jig main body 30 is connected to the exhaust means 70, and the interior of the lens holding tool 2 is evacuated, an outer periphery 103 of the optical surface 102 of the lens 100 is in tight contact with an inner edge 43 of the holding portion 41 and held by it. At this time, the hollow portion 38 in the lens holding tool 2 is evacuated. In this embodiment as well, as shown in FIG. 4, the edge 33 of the jig main body 30 desirably forms a taper surface 33a inclined inward, so if the optical surface 102 of the lens 100 on the hollow portion 38 side is a convex, the edge 33 does not come into contact with the lens 100.

After holding the lens 100, the lens holding tool 2 is transported to a surface processing apparatus (not shown), in the same manner as in the embodiment described above, and an optical surface 101 of the lens 100 undergoes coating. In this embodiment as well, the optical surface 101 of the lens 100 undergoes a surface process such as coating of a coating material by a processing apparatus such as a coating bath. After that, the lens holding tool 2 is transported to a curing bath that performs curing by ultraviolet irradiation or the like, and the coating material is cured by ultraviolet irradiation or the like, as indicated by an arrow d in FIG. 4.

In this embodiment as well, temperature rise of the lens holding tool 2 can be suppressed in the same manner as in the first embodiment described above. More specifically, the lens 100 is in contact with the lens holding tool 2 through only the outer peripheral edge 24. Thus, the area of the lens 100 which is in the direction of ultraviolet irradiation is considerably smaller than in a case in which the lens 100 is held by a conventional sucking pad or the like. Most of the area of the convex optical surface 102 is not in contact with the lens holding body 40. Hence, heat is not retained in the lens 100 but is dissipated outside, so heat accumulation in the lens holding tool 2 is suppressed. This can reliably reduce temperature rise of the lens holding tool 2.

In the first and second embodiments described above, the holding portions 21 and 41 of the lens holding bodies 20 and 40 have a V-shaped section and O-shaped section, respectively. However, the sectional shape of the holding portion is not limited to them, but the holding portion can have various other sectional shapes such as a U-shaped section and W-shaped section.

The connection mode of the connecting portion 36 with the exhaust means 70 is not limited to threadable connection as in the example shown in FIG. 4 but can include various connection modes. For example, the upper plate portion 34 of the jig main body 30 may be provided with a ring-like projection or recess that serves as a connecting portion, and a sucking means having an open end matching the shape of the connecting portion may be fitted with the connecting portion. Alternatively, the connecting portion may be connected to the distal end opening of the exhaust means 70 through an elastic member such as an O-ring. More specifically, the connecting portion 36 can have any shape as far as it can maintain air tightness. Desirably, it suffices as far as the lens holding tool 1 or 2 can be attached to and removed from the connecting portion 36 easily.

### (3) Third Embodiment

### Lens Holding Tool

A lens holding tool 80 according to the third embodiment of the present invention shown in FIG. 5 includes a jig main body 10 described in the first embodiment and a lens holding body 40 described in the second embodiment. Conversely, the lens holding tool of the third embodiment may be the one obtained by fitting a lens holding body 20 employed in the first embodiment with a jig main body 30 employed in the second embodiment. The lens holding tool 80 of the third embodiment can include various combinations of a jig main body and lens holding body.

In the lens holding tool 80, an inner edge 43 of the lens holding body 40 is brought into contact with, of an outer peripheral edge 24 of a lens 100, only an outer periphery 103 of a convex optical surface 102 and not with a side surface 104, and evacuation is performed through a vent hole 15 as indicated by an arrow e, so that the outer periphery of the optical surface 102 is sucked and held by the lens holding body 40.

In this manner, when sucking and holding only the outer periphery of the optical surface 102 of the lens 100, if a hollow portion 18 is evacuated, the tight contact of the outer periphery 103 of the lens 100 with the lens holding body 40 is maintained, so the lens 100 can be held stably. In this case as well, if curing by ultraviolet irradiation or the like is performed as indicated by an arrow f, since most of the optical surface 102 of the lens 100 is not in contact with the lens holding body 40, heat in the lens 100 is not retained but is dissipated outside, so that the temperature rise of the lens holding tool 80 can be suppressed. Although the embodiment shown in FIG. 5 shows a case in which an edge 13 of a second cylindrical portion 11b of the jig main body 10 forms a curved taper surface, it may form a flat taper surface 13a (FIG. 2) as in the first embodiment. The edge 13 may be a flat surface or the like including a curved surface. The edge 13 of the jig main body 10 can have any shape as far as the optical surface 102 does not come into contact with it even when a holding portion 41 elastically deforms during evacuation.

### (4) Fourth Embodiment

### Lens Holding Tool

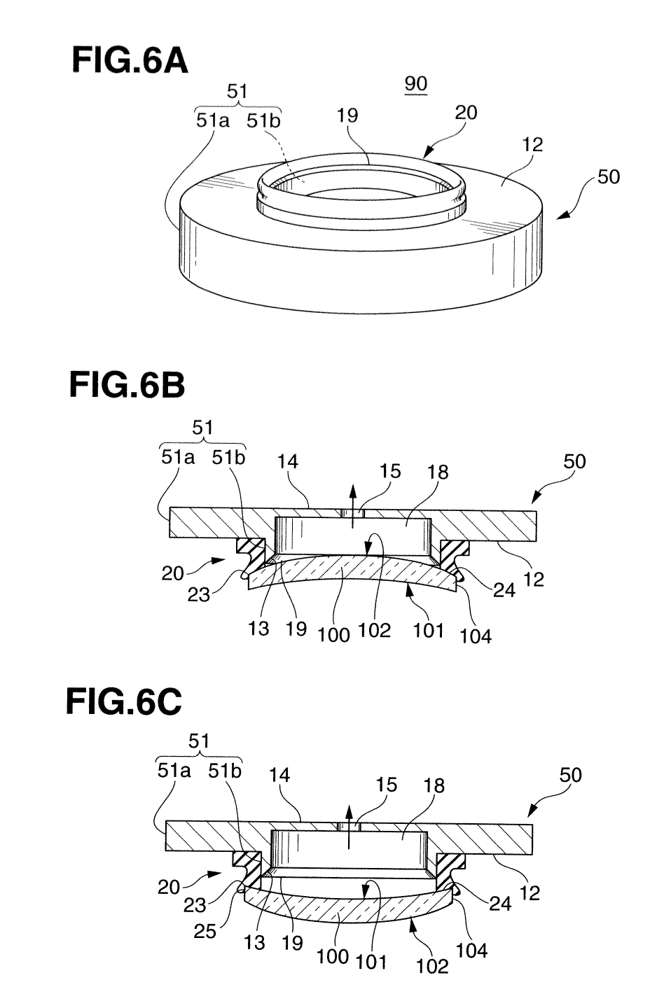

A lens holding tool 90 according to the fourth embodiment of the present invention shown in FIGS. 6A, 6B and 6C are employed for a small-diameter lens 100 having a diameter of approximately 60 mm or less, and includes a cylindrical jig main body 50 and a lens holding body 20 shown in the first embodiment. The jig main body 50 is formed into a cylindrical shape with one open end so it includes a circular flat upper plate portion 14 and a cylindrical portion 51. The cylindrical portion 51 includes a thick-walled ring-like first cylindrical portion 51a continuous to the upper plate portion 14, and a second cylindrical portion 51b thinner-walled than the first cylindrical portion 51a and having an outer diameter smaller than that of the first cylindrical portion 51a. One end of the second cylindrical portion 51b forms an edge 13 of an opening 19. The outer diameter of the first cylindrical portion 51a is equal to that of each of the first cylindrical portion 11a of the jig main body 10 of the first embodiment shown in FIG. 1 and the first cylindrical portion 31a of the jig main body 30 of the second embodiment shown in FIG. 3. The outer diameter of the second cylindrical portion 51b is smaller than that (e.g., 60 mm in diameter) of the lens 100.

The lens holding body 20 is fitted on the outer surface of the second cylindrical portion 51b. Upon evacuation of the lens holding tool 90, a holding portion 21 sucks and holds an outer peripheral edge 24 of the lens 100. In this case, in FIG. 6B, the lens holding body 20 sucks and holds the outer peripheral edge 24 of a convex optical surface 102 of the lens 100, more specifically, the outer periphery and a side surface 104 of the convex optical surface 102, in the same manner as in the first embodiment shown in FIG. 1. In FIG. 6C, the lens holding body 20 sucks and holds an outer peripheral edge 25 of a concave optical surface 101 of the lens 100, more specifically, the outer periphery and the side surface 104 of the concave optical surface 101.

In this lens holding tool 90, as the outer diameter of the first cylindrical portion 51a is equal to that of each of the first cylindrical portion 11a of the jig main body 10 and the first cylindrical portion 31a of the jig main body 30, the jig attaching portion of the processing apparatus need not be exchanged for each lens holding tool but can be used in common.

According to the fourth embodiment, at least two types of lens holding tools having different opening diameters are prepared in accordance with the lens diameters. When holding a lens, a lens holding tool having an opening diameter that matches the diameter of the lens to be held is selectively used, and holds the lens.

### (5) Lens Processing Method

A lens processing method of holding a lens and processing the surface of the lens using a lens holding tool according to the present invention described above will now be described.

The content of lens process performed in this embodiment may suffice as far as it includes sucking and holding an outer peripheral edge 24 of a lens 100 by a lens holding tool according to the present invention, e.g., a lens holding tool 1 of the first embodiment, and processing only an optical surface 101 on a side opposite to the lens holding tool 1. For example, the lens processing method can be applied to irradiation of a beam such as ultraviolet rays described above, cleaning, and the like, in addition to coating such as spin coating.

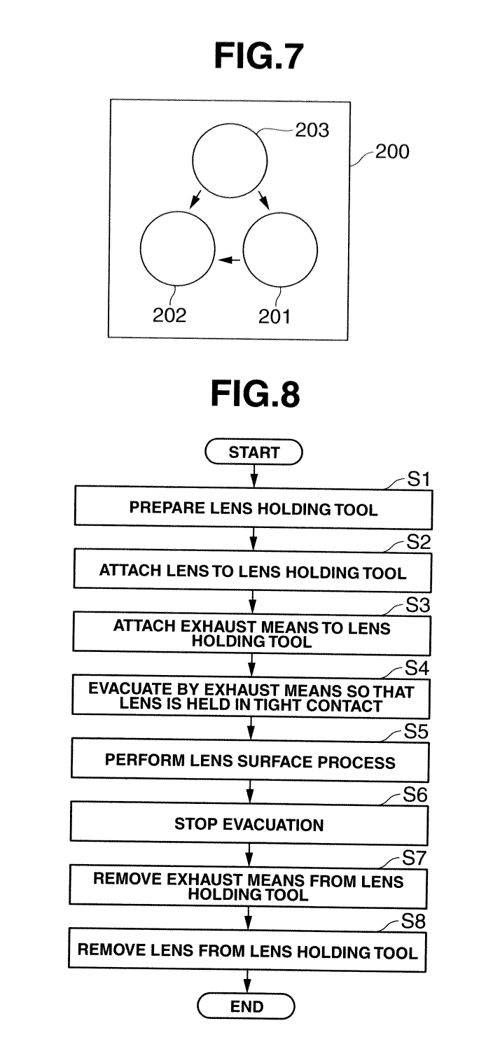

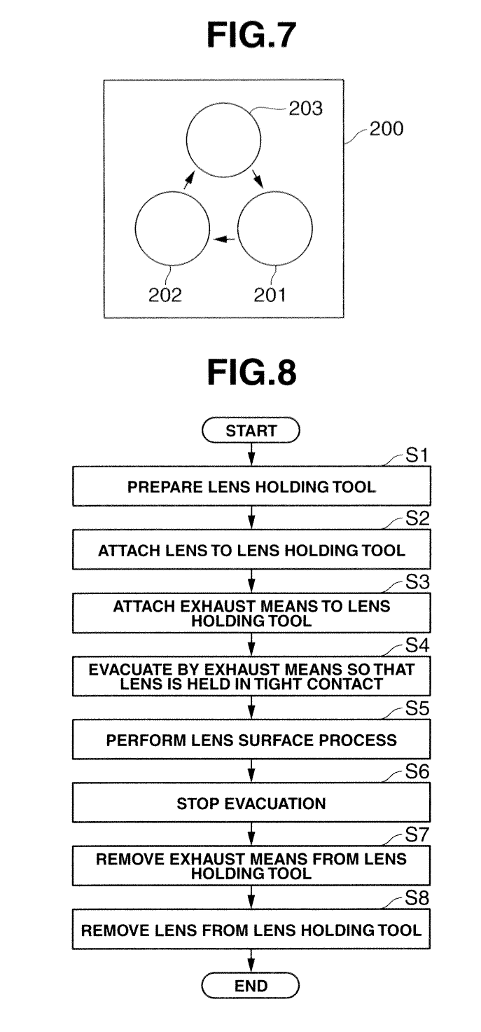

As an example, a case will be described in which a processing apparatus 200 shown in FIG. 7 performs coating and curing by ultraviolet irradiation for the concave optical surface 101 of the lens 100. Referring to FIG. 7, the processing apparatus 200 includes three stages 201 to 203. The lens holding tool 1 which sucks and holds the lens is attached to the first stage 201. On the second stage 202, the lens undergoes coating of a primer layer or hard coating. On the third stage 203, the lens undergoes ultraviolet curing of a film formed by coating.

Steps in the lens processing method using the processing apparatus 200 will be described with reference to the flowchart of FIG. 8.

First, any one of the lens holding tools described in the first to fourth embodiments, e.g., the lens holding tool 1 is prepared (step S1). The lens 100 is attached to the lens holding tool 1 (step S2). When the lens holding tool 1 is employed, the lens 100 is attached by fitting it in the lens holding tool 1, as described above. When a lens holding tool 80 shown in FIG. 5 is employed, it is brought into tight contact with the outer periphery of an optical surface 102 of the lens from above.

For example, the lens holding tool 1 is set on the first stage 201 of the processing apparatus 200 as shown in FIG. 7, and an exhaust means provided to the processing apparatus 200 is attached to the upper surface or connecting portion of the lens holding tool 1 (step S3). At this time, with the lens holding tool 1 of the first embodiment, for example, only a sucking pad (FIG. 2) attached to the distal end of the exhaust means needs to be brought into tight contact with an upper plate portion 14. This simplifies the operation. With a lens holding tool 2 of the second embodiment, the distal end of an exhaust means 70 is connected to a connecting portion 36. After that, the interior of the lens holding tool 1 is evacuated by the exhaust means (step S4). When the interior of the lens holding tool is evacuated, a hollow portion 18 surrounded by the lens holding tool 1 and lens 100 is evacuated, and the outer peripheral edge 24 of the lens 100 is stably sucked and held by the lens holding tool 1.

Then, the lens holding tool 1 is moved to the second stage 202 where a surface process is to be performed. For example, the second stage 202 is a coating bath that performs spin coating. While being held by the lens holding tool 1, the lens 100 is rotated by, e.g., a rotating means. The coating material is dripped onto the optical surface 101, so it coats the entire optical surface 101 by the centrifugal force. After the coating process, the lens holding tool 1 is moved to the third stage 203, and the coating material is cured by, e.g., ultraviolet irradiation (step S5).

After that, the lens holding tool 1 is moved from the third stage 203 to the first stage 201, and evacuation by the exhaust means is stopped (step S6). The exhaust means is removed from the lens holding tool 1 (step S7). The lens holding tool 1 is taken out of the processing apparatus 200, and the lens 100 is removed from the lens holding tool 1 (step S8).

A series of processes for the optical surface 101 of the lens 100 is ended through the above processing steps. When the optical surface is to be processed in this manner using the lens holding tool 1 of the present invention, the outer peripheral edge 24 of the lens 100, that is, a very narrow range covering the outer periphery to a side surface 104 of the optical surface 102 is held. Thus, when performing, e.g., ultraviolet irradiation, temperature rise in the lens 100 and lens holding tool 1 can be suppressed. Therefore, when processing a plurality of lenses consecutively by holding them by the lens holding tool 1, heat is not accumulated in the lens holding tool 1, so that coating films can be formed on the optical surfaces while variations in film thickness are controlled. The process can be performed in the same manner when the lens holding tool 2 or 80, or a lens holding tool 90 is employed as well.

In processing a plurality of lenses consecutively, when a jig main body 30 of the lens holding tool 2 of the second embodiment is to be employed, step S7 may be omitted, and the process may advance to the next step with the lens holding tool 2 remaining connected to the exhaust means 70. More specifically, with the lens holding tool 2 having the connecting portion 36, when processing a lens from the second one, after step S8, the process returns to the step S2. Omitting step S3, the process advances to steps S4 and S5. In step S6, evacuation is stopped, and the process goes on to step S8. By repeating this procedure, a plurality of lenses can be processed consecutively.

When a jig main body 10 of the lens holding tool 1 of the first embodiment is employed, in steps S3 and S7 described above, the lens holding tool 1 is attached to and removed from the evacuation means such as the sucking pad 60. At this time, a plurality of lens holding tools 1 are prepared and lenses are removed from them outside the processing apparatus, so that the time interval between the operations of attaching the lens holding tool 1 to the exhaust means of the processing apparatus can be minimized. This can improve the lens productivity of the processing apparatus. Since the lens holding tool 1 is exchanged for each process, heat accumulation in the lens holding tool 1 can be further suppressed.

Using this processing apparatus, the surface process for the lens was performed, and variations in film thickness were studied. The obtained results be described hereinafter.

In the following examples, the jig main bodies 10 and 30 described in the first and second embodiments were employed in Examples 1 and 2, respectively. In each example, the lens process was performed using a lens holding body 20 with a holding portion 21 having a V-shaped section shown in FIGS. 1A to 1E. In Example 1, six lens holding tools were prepared. The sucking pad 60 shown in FIG. 2 was used as the exhaust means. The lens holding tool was exchanged for each lens to be processed, thereby attaching and removing the lens holding tool to and from the sucking pad 60.

In Example 2, the lens holding tool was not exchanged. With the exhaust means 70 kept connected to the connecting portion 36 of the jig main body 30, only lens exchange was performed on the first stage 201 of the processing apparatus 200 shown in FIG. 7.

The lens 100 was made of polycarbonate, and the coating material to be applied to the lens surface was hard coating liquid. The hard coating liquid contained silica and an acrylic resin. As the solvent, PGM (Propylene Glycol Monomethylether) was used.

The coating material was applied to the concave optical surface 101 of the lens 100. Coating was performed initially at a rotation speed of 1,250 rpm for 20 sec, and then 1,500 rpm for 10 sec. One lens underwent coating with a cycle of 30 sec. After that, the lens underwent ultraviolet irradiation for 30 sec, so that the hard coating layer was cured.

In measuring the film thickness, the lens center was determined as point 1, and locations every 15 mm from the point 1 toward the outer periphery were determined as point 2, point 3, and the like. The difference between the lens inner surface portion (point 1) and outer surface portion (point 3) was obtained as variations in film thickness. Also, the presence/absence of interference fringes was checked by visual observation.

In Comparative Example 1, none of the lens holding tools of the present invention was employed. The lens was held by sucking its convex optical surface directly by a funnel-like sucking pad 60 having the same shape as that shown in FIG. 2. The surface process (coating and curing) was performed under the same conditions. In each of the above Examples 1 and 2 and Comparative Example 1, six lenses underwent the surface process, and their film thicknesses and the like were measured. The following Table 1 shows the results. In the items of appearance and remarks of Table 1, states in which interference fringes were not observed, hardly observed, somewhat observed, and clearly observed were indicated by ⊚, ◯, Δ, and x, respectively.

TABLE 1

| | | | | | | | | Appear- | |
|---|---|---|---|---|---|---|---|---|---|
| | | | | | | | Differ- | ance | |
| | | | | | | | ence | (Inter- | Remarks |
| | | | | Film Thickness (μm) | | | Point 3- | ference | Position of Interference |
| | Type | Cure | Sample | Point 1 | Point 2 | Point 3 | Point 1 | Fringes) | Fringes: State) |
| Example | Lens | UV | 1-1 | 3.26 | 3.27 | 3.46 | 0.20 | ⊚ | Center, Outer Periphery: ⊚ |
| 1 | Hold- | Irra- | 1-2 | 3.26 | 3.29 | 3.53 | 0.27 | ⊚ | Center, Outer Periphery: ⊚ |
| | ing | dia- | 1-3 | 3.34 | 3.28 | 3.32 | −0.02 | ⊚ | Center, Outer Periphery: ⊚ |
| | Tool A | tion | 1-4 | 3.24 | 3.12 | 3.35 | 0.11 | ⊚ | Center, Outer Periphery: ⊚ |
| | | 30 s | 1-5 | 3.26 | 3.17 | 3.28 | 0.02 | ⊚ | Center, Outer Periphery: ⊚ |
| | | | 1-6 | 3.33 | 3.39 | 3.32 | −0.01 | ⊚ | Center, Outer Periphery: ⊚ |
| Example | Lens | | 2-1 | 3.31 | 3.34 | 3.58 | 0.27 | ⊚ | Center, Outer Periphery: ⊚ |
| 2 | Hold- | | 2-2 | 3.28 | 3.44 | 3.42 | 0.14 | ⊚ | Center, Outer Periphery: ⊚ |
| | ing | | 2-3 | 3.17 | 3.27 | 3.40 | 0.23 | ⊚ | Center, Outer Periphery: ⊚ |
| | Tool B | | 2-4 | 3.16 | 3.29 | 3.63 | 0.47 | ◯ | Center ⊚, Outer Periphery: ◯ |
| | | | 2-5 | 3.10 | 3.32 | 3.62 | 0.52 | ◯ | Center ⊚, Outer Periphery: ◯ |
| | | | 2-6 | 3.19 | 3.29 | 3.63 | 0.44 | ◯ | Center ⊚, Outer Periphery: ◯ |
| Compara- | Lens | | 3-1 | 3.15 | 3.15 | 3.24 | 0.09 | Δ | Center, Outer Periphery: Δ |
| tive | Hold- | | 3-2 | 3.05 | 3.15 | 3.16 | 0.11 | Δ | Center, Outer Periphery: Δ |
| Example | ing | | 3-3 | 3.35 | 3.05 | 3.11 | −0.24 | Δ | Center, Outer Periphery: Δ |
| 1 | Tool C | | 3-4 | 3.36 | 3.04 | 2.83 | −0.53 | X | Center, Outer Periphery: X |
| | | | 3-5 | 3.38 | 3.07 | 2.76 | −0.62 | X | Center, Outer Periphery: X |
| | | | 3-6 | 3.29 | 3.12 | 2.79 | −0.50 | X | Center, Outer Periphery: X |

From the results shown in Table 1, both the lens holding tools of Examples 1 and 2 suppressed variations in film thickness and occurrence of interference fringes. In particular, with the lens holding tool of Example 1, a good state was obtained until the sixth lens with no interference fringes observed at the center and outer periphery. With the lens holding tool of Example 2, although the film thickness slightly changed and interference fringes were observed very slightly in lenses from the fourth one, they were of no problem in terms of practical use. To eliminate interference fringes, the outer periphery may be ground. Namely, when processing a lens having a comparatively small diameter, the lens holding tool of Example 2 can also be suitably employed.

With the lens holding tool of Example 1, in consecutive processing, the lens holding tool is exchanged for each lens. Therefore, temperature rise in the lens holding tool is further suppressed to reduce variations in film thickness, so that a coating film can be formed stably. With the lens holding tool of Example 1, no additional connecting portion need be provided at the distal end of the exhaust means, and the lens is held by drawing it by suction together with the lens holding tool using only a sucking pad having a simple arrangement. Therefore, the attaching and removing operation of the lens holding tool on the first stage of the processing apparatus 200 described above becomes very simple, which is advantageous.

When lenses have different diameters, different lens holding tools are desirably prepared for them respectively. For example, when the lens diameters vary within a range of approximately 55 mm to 80 mm, the lens holding tools may be color-coded, e.g., red for the lens holding tool for the 55-mm diameter lenses and blue for the lens holding tool for the 80-mm diameter lenses. Then, in the processing steps, the lens attaching operation and the like become further simpler.

The surface process to be performed using the lens holding tool of the present invention is not limited particularly as far as it is a process for one surface of the lens. In addition to coating such as spin coating and ultraviolet curing described above, the present invention can also be applied to various types of wet processes such as cleaning. Furthermore, the lens holding tool of the present invention holds the lens air-tightly to cover a portion ranging from the side surface to the outer periphery of the non-processing optical surface of the lens. Accordingly, this lens holding tool is more suitable when processing only one surface of the lens is desired.

Although embodiments of the present invention are described so far, the present invention is not limited to the embodiments described above, and various changes and modifications are incorporated in the present invention as far as they do not depart from the spirit and scope of the present invention defined in the appended claims.

1. A lens holding tool comprising:
a cylindrical jig main body including an opening, a vent hole, and a hollow portion communicating with the vent hole; and
a ring-like lens holding body formed of an elastic body,
wherein said lens holding body includes a fitting portion which fits with said jig main body and a holding portion which holds an outer peripheral edge of a lens as a holding target, and upon evacuation through the vent hole, the hollow portion is evacuated, and the holding portion deforms, thereby sucking and holding the outer peripheral edge of the lens.

2. A lens holding tool according to claim 1, wherein said jig main body includes a taper surface inside an edge that fits with said lens holding body.

3. A lens holding tool according to claim 2, wherein said lens holding body has an inner diameter smaller than an outer diameter of the edge of said jig main body.

4. A lens holding tool according to claim 1, wherein the outer peripheral edge of the lens which is to be held by said lens holding body comprises at least one of an outer periphery and side surface of an optical surface that opposes said jig main body.

5. A lens holding tool according to claim 1, wherein said lens holding body includes one of a V-shaped section and an O-shaped section.

6. A lens holding tool according to claim 1, wherein said jig main body is further provided with a connecting portion, in a region surrounding the vent hole, to be connected to exhaust means.

7. A lens holding tool according to claim 1, wherein
the opening of said jig main body is substantially circular, and
said lens holding body is substantially circular.

8. A lens holding method comprising the steps of:
preparing a lens holding tool in which a lens holding body including a fitting portion and a holding portion and formed of a ring-like elastic body is fitted with an edge of an opening of a cylindrical jig main body including the opening, a vent hole, and a hollow portion communicating with the vent hole;
mounting a lens on the lens holding tool;
attaching exhaust means to a region surrounding the vent hole of the jig main body; and
evacuating an interior of the lens holding tool by the exhaust means, thereby sucking and holding an outer peripheral edge of the lens by the lens holding tool.

9. A lens holding method according to claim 8, wherein
the exhaust means is further provided with a sucking pad at a distal end thereof, and
the vent hole is covered by attaching the sucking pad to the jig main body, and an interior of the lens holding tool is evacuated by the exhaust means, thereby sucking and holding the outer peripheral edge of the lens by the lens holding tool.

10. A lens holding method according to claim 9, wherein
a plurality of lens holding tools are prepared,
lenses are attached to the plurality of lens holding tools, respectively, and
when exchanging lenses, the lens holding tool which is in tight contact with the sucking pad is exchanged.

11. A lens holding method according to claim 8, wherein
the jig main body is provided with a connecting portion to be connected to the exhaust means such that the connecting portion surrounds the vent hole, and
a connecting portion of the exhaust means is connected to the connecting portion of the jig main body and an interior of the lens holding tool is evacuated.

12. A lens holding hod according to claim 8, wherein
at least two types of lens holding tools having different opening diameters are prepared, and
the lens is held using one of the lens holding tools which has an opening diameter matching a diameter of the lens to be held.

13. A lens processing method comprising the steps of:
preparing a lens holding tool in which a lens holding body including a fitting portion and a holding portion and formed of a ring-like elastic body is fitted with an edge of an opening of a cylindrical jig main body including the opening, a vent hole, and a hollow portion communicating with the vent hole,
mounting a lens on the lens holding tool;
attaching exhaust means to a region surrounding the vent hole of the jig main body;
evacuating an interior of the lens holding tool by the exhaust means, thereby sucking and holding an outer peripheral edge of the lens by the lens holding tool;
moving the lens holding tool to a processing bath that processes a surface of the lens; and
processing the surface of the lens.
